(19) United States
(12) Patent Application Publication
(10) Pub. No.: US 2015/0326786 A1
(43) Pub. Date: Nov. 12, 2015

(54) IMAGE PROCESSING DEVICE, IMAGING DEVICE, AND IMAGE PROCESSING METHOD

(71) Applicant: KABUSHIKI KAISHA TOSHIBA, Tokyo (JP)

(72) Inventors: Nao MISHIMA, Tokyo (JP); Takeshi MITA, Yokohama (JP)

(21) Appl. No.: 14/700,286

(22) Filed: Apr. 30, 2015

(30) Foreign Application Priority Data
May 8, 2014 (JP) 2014-097052

(51) Int. Cl. H04N 5/232; H04N 1/21

(52) U.S. Cl. CPC H04N 5/23267; H04N 5/23254; H04N 5/23277; H04N 1/2112

(57) ABSTRACT

According to one embodiment, an image processing device includes memory and a calculator. The memory stores a first storage image. The calculator stores at least a portion of a target image in the first storage image. The calculator determines to set a reference image to be the target image when a relationship between the reference image and the target image satisfies a determination condition, the storing being based on a motion vector between the reference image and the target image.

### CROSS-REFERENCE TO RELATED APPLICATIONS

This application is based upon and claims the benefit of priority from Japanese Patent Application No. 2014-097052, filed on May 8, 2014; the entire contents of which are incorporated herein by reference.

### FIELD

Embodiments described herein relate generally to an image processing device, an imaging device, and an image processing method.

### BACKGROUND

For example, there is an image processing device that adds multiple input frames and generates an output frame. It is desirable to improve the image quality of the image for such an image processing device.

### BRIEF DESCRIPTION OF THE DRAWINGS

FIG. 1 is a block diagram showing an image processing device according to a first embodiment;

FIG. 2 is a flowchart showing operations of the image processing device according to the first embodiment;

FIG. 3 is a schematic view showing the operations of the image processing device according to the first embodiment;

FIG. 4 is a schematic view showing operations of the image processing device according to the first embodiment.

FIG. 5 is a schematic view showing operations of the image processing device according to the first embodiment.

FIG. 6 is a block diagram showing an image processing device according to a second embodiment;

FIG. 7 is a schematic view showing operations of the image processing device according to the second embodiment;

FIG. 8 is a schematic view showing an image processing device according to a third embodiment; and

FIG. 9 is a schematic view showing an imaging device according to a fourth embodiment.

### DETAILED DESCRIPTION

According to one embodiment, an image processing device includes memory and a calculator. The memory stores a first storage image. The calculator adds at least a portion of a target image to the first storage image based on a motion vector between a reference image and the target image. The calculator determines to replace the reference image with the target image when a relationship between the reference image and the target image satisfies a determination condition.

According to one embodiment, an imaging device includes an image processing device and an imaging element. The image processing device includes memory and a calculator. The memory stores a first storage image. The calculator adds at least a portion of a target image to the first storage image based on a motion vector between a reference image and the target image. The calculator determines to replace the reference image with the target image when a relationship between the reference image and the target image satisfies a determination condition. The imaging element images the target image.

According to one embodiment, an image processing method is disclosed. The method includes acquiring a target image and adding at least a portion of the target image to a first storage image based on a motion vector between a reference image and the target image. The method includes replacing the reference image with the target image when a relationship between the reference image and the target image satisfies a determination condition.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even in the case where the same portion is illustrated.

In the drawings and the specification of the application, components similar to those described in regard to a drawing thereinabove are marked with like reference numerals, and a detailed description is omitted as appropriate.

### First Embodiment

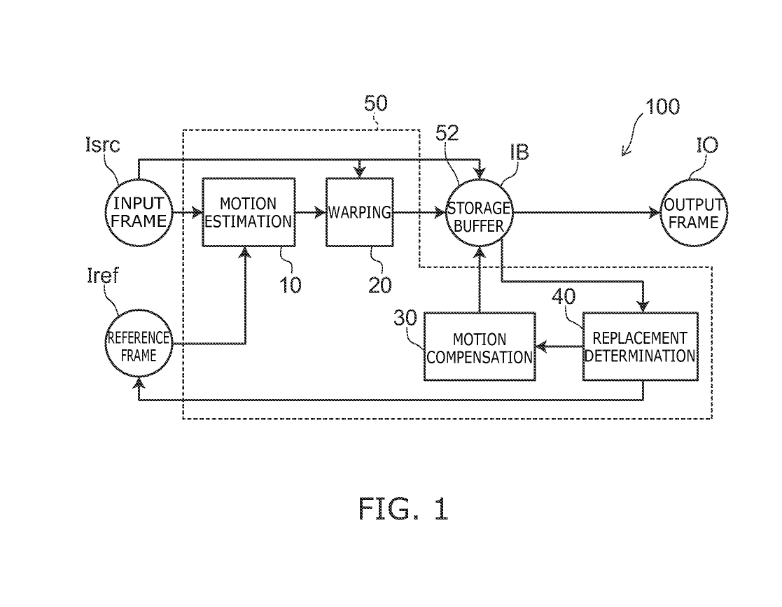

FIG. 1 is a block diagram illustrating an image processing device according to a first embodiment.

As shown in FIG. 1, the image processing device 100 according to the first embodiment includes a calculator 50 and memory 52. As shown in FIG. 1, the calculator 50 includes a motion estimator 10, a warping unit 20, a motion compensator 30, and a replacement determination unit 40.

The calculator 50 acquires an input frame Isrc (an input image). As described below, multiple input frames Isrc are acquired in the operations of the image processing device 100. The input frame Isrc is, for example, one frame of a video image. For example, the multiple input frames Isrc are input to the image processing device 100 moment to moment from an image sensor, television images, etc. The image processing device 100 generates a high-quality image by storing the multiple input frames Isrc. However, in the embodiment, the input frame Isrc may be one frame of a still image.

The memory 52 is used to store the images. For example, a storage buffer (a first storage image) is stored in the memory 52. The input frame Isrc is stored in a storage buffer IB (a first storage image). When storing the input frame Isrc, the shift (a motion vector) between a reference frame Iref (a reference image) and the input frame Isrc is determined by the motion estimator 10. For example, the shift is caused by hand unsteadiness of a camera, etc.

In the warping unit 20, the input frame Isrc is aligned with the reference frame Iref according to the shift that is determined. The aligned input frame Isrc is stored in the storage buffer IB. Thereby, for example, noise removal (hand unsteadiness correction) can be performed.

Thus, an output frame IO is output using the storage buffer IB in which the multiple input frames Isrc are stored. Thereby, a high-quality image is generated. The input frame Isrc is aligned with the reference frame Iref that is separated from the storage buffer IB. Thereby, the accumulation of alignment errors can be suppressed. The motion compensator 30 and the replacement determination unit 40 are described below.

The block diagram is an example of the image processing device according to the embodiment and does not necessarily match the configuration of an actual program module.

An integrated circuit such as LSI (Large Scale Integration), etc., or an IC (Integrated Circuit) chipset may be used as a portion of the image processing device according to the embodiment or the entire image processing device according to the embodiment. An individual processor may be used in each functional block. A processor that integrates some or all of the functional blocks may be used. The integrated circuit is not limited to LSI; and an integrated circuit that uses a dedicated circuit or a general-purpose processor may be used.

The value at the coordinates (x, y) of the input frame Isrc is defined as I_{src}(x, y). For example, the value of the input frame Isrc is a scalar such as a luminance value. The value of the input frame Isrc may be a vector such as that of a color image (RGB or YUV).

The output frame IO is the image of the processed result. The value at the coordinates (x, y) of the output frame IO is defined as O(x, y).

The reference frame Iref is a frame used as the reference of the storing. For example, one frame of the input image is used as the reference frame Iref. For example, when starting the processing, the initial frame is used as the reference frame. The value of the reference frame Iref at the coordinates (x, y) is defined as I_{ref}(x, y).

The storage buffer IB is a buffer (a frame) for storing the input frame Isrc aligned with the reference frame Iref. The resolution of the storage buffer IB may not be the same as the resolution of the input frame Isrc. For example, the resolution of the storage buffer IB may be 2 times, 3 times, or 4 times that of the input frame Isrc in the vertical direction and the horizontal direction. For example, a super-resolution effect occurs by increasing the resolution. Thereby, a high-quality image can be generated. The resolution of the storage buffer IB may be lower than the resolution of the input frame Isrc. The coordinates of the storage buffer IB are the coordinates (X, Y). The value at the coordinates (X, Y) of the storage buffer IB is defined as B(X, Y).

In the embodiment, a weight that is described below is considered for each of the pixels of the storage buffer IB when generating the output frame IO from the storage buffer IB.

The weight is stored in a storing weight buffer IW. The resolution of the storing weight buffer IW is the same as the resolution of the storage buffer IB. The value at the coordinates (X, Y) of the storing weight buffer IW is defined as W(X, Y).

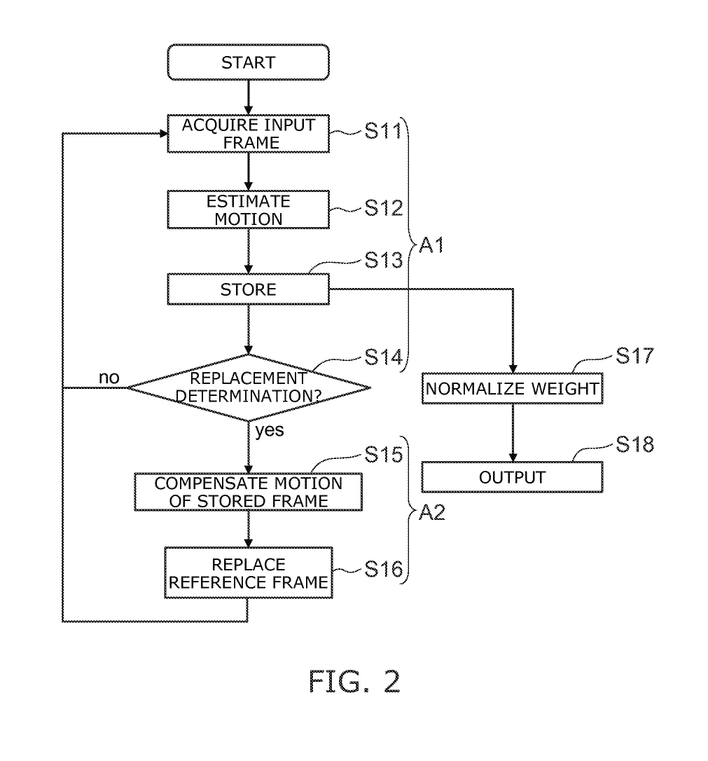

FIG. 2 is a flowchart illustrating operations of the image processing device according to the first embodiment.

As shown in FIG. 2, the image processing device 100 implements a first operation A1 and a second operation A2. The first operation A1 includes steps S11 to S14. The second operation A2 includes steps S15 and S16.

In step S11, the motion estimator 10 acquires the input frame Isrc (the target image).

In step S12 (the motion estimation), the motion estimator 10 detects the motion vector from the input frame Isrc to the reference frame Iref. For example, the difference between the position of a subject (an object) in the input frame Isrc and the position of the same subject in the reference frame Iref is expressed by the motion vector.

Various methods may be used to detect the motion vector; and, for example, block matching may be used. However, in the embodiment, the method for detecting the motion vector is not limited to block matching. Block matching is a method that includes subdividing the input frame Isrc into rectangular blocks and searching for the block in the reference frame Iref that corresponds to each block. For one block, M₁ is the length in the X-axis direction; and M2 is the length in the Y-axis direction. The position of the block is (i, j).

The mean absolute difference (MAD), etc., may be used as the error function for determining the motion.

$$\begin{matrix} [ Formula 1 ] & \\ MAD ( i , j , u ) = \frac{1}{{M}_{1} {M}_{2}} {\sum }_{0 \leq m < {M}_{J} , 0 \leq n < {M}_{2}} \vert {I}_{src} ( {M}_{1} i + m , {M}_{2} j + n ) - {I}_{ref} ( {M}_{1} i + m + {u}_{x} , {M}_{2} j + n + {u}_{y} ) \vert & ( 1 )\end{matrix}$$

Here, the vector u=(uₓ, u_{y})^{T} is the motion vector to be evaluated. T is the transpose.

The mean squared error may be used as the error function. In the case where the range of search is the rectangular region of −W≦x≦W and −W≦y≦W, the following block matching algorithm determines the motion vector u(i, j) at the position (i, j).

$$\begin{matrix}[ Formula 2 ] & \\ {u}_{LM} ( i , j ) = {argmin}_{- W \leq {u}_{x} \leq W , - W \leq {u}_{y} \leq W} MAD ( i , j , {( {u}_{x} , {u}_{y} )}^{T} ) & ( 2 )\end{matrix}$$

Here, the search for uₓ and u_{y} to minimize an error function E is expressed by

$$\begin{matrix}[ Formula 3 ] & \\ {argmin}_{- W \leq {u}_{x} \leq W , - W \leq {u}_{y} \leq W} E & ( 3 )\end{matrix}$$

The motion vector inside the block is the same as the motion vector of the block. Namely,

[Formula 4]

u(x,y):=u(i,j) (4)

The matching may be performed with a precision that includes positions having coordinates expressed in decimals. For example, isometric linear fitting or the like may be used. Here, the motion vector may not be detected; and, for example, a motion vector that is used for compression by video encoding such as MPEG2 may be used. The motion vector that is decoded by a decoder may be used.

When detecting the motion vector, the parametric motion that expresses the motion of the entire screen may be determined. For example, the parametric motion of the entire screen is determined using the Lucas-Kanade method. The motion vector is determined from the parametric motion that is determined.

The parametric motion expresses the motion using a parameterized projection. For example, the motion of the coordinates (x, y) may be expressed as follows using an affine transformation.

$$\begin{matrix}[ Formula 5 ] & \\ p ( x , y ) a = [ \begin{matrix}x & y & 1 & 0 & 0 & 0 \\ 0 & 0 & 0 & x & y & 1\end{matrix} ] [ \begin{matrix}{a}_{0} \\ {a}_{1} \\ {a}_{2} \\ {a}_{3} \\ {a}_{4} \\ {a}_{5}\end{matrix} ] & ( 5 )\end{matrix}$$

The vector a=(a₀, a₁, a₂, a₃, a₄, a₅)^{T} is a parameter that expresses the motion. Such a motion parameter is estimated from the entire screen using the Lukas-Kanade method. In the Lukas-Kanade method, the following steps 1 to 4 are implemented.

Step 1:

The gradient

$$\begin{matrix}[ Formula 6 ] & \\ ∇ {I}_{ref} = ( \frac{\partial {I}_{ref}}{\partial x} , \frac{\partial {I}_{ref}}{\partial y} ) & ( 6 )\end{matrix}$$

is calculated.

Step 2:

The Hessian matrix

$$\begin{matrix} [ Formula 7 ] & \\ H = {\sum }_{x , y} {( ∇ {I}_{ref} ( p ( x , y ) {a}^{( t - 1 )} ) p ( x , y ) )}^{T} ( ∇ {I}_{ref} ( p ( x , y ) {a}^{( t - 1 )} ) p ( x , y ) ) & ( 7 )\end{matrix}$$

is calculated.

Step 3:

$$\begin{matrix} [ Formula 8 ] & \\ Δ a = {H}^{- 1} {\sum }_{x , y} {( ∇ {I}_{ref} ( p ( x , y ) {a}^{( t - 1 )} ) p ( x , y ) )}^{T} ( {I}_{src} ( x , y ) - {I}_{ref} ( p ( x , y ) {a}^{( t - 1 )} ) ) & ( 8 )\end{matrix}$$

is calculated.

Step 4:

The update

[Formula 9]

a^{(t)}=a^{(t-1)}+Δa (9)

is calculated. Step (2) to (4) are repeated until a specified number is reached. Here, the number of iterations is expressed by the superscript t.

When the parameters have been determined, the motion vector at any coordinate position can be determined by

[Formula 10].

u(x,y)=p(x,y)a−(x,y)^{T} (10)

Also, for example, a feature point may be calculated for each of the two frames; and the parametric motion may be determined from the association between the feature points.

The input frame Isrc is stored in the storage buffer IB in step S13.

As described above, there are cases where the resolution of the storage buffer IB is different from the resolution of the input frame Isrc. Therefore, when storing, the scale of the motion vector determined at the resolution of the input frame Isrc is converted to correspond to the resolution of the storage buffer IB.

[Formula 11]

U(x,y)=ρu(x,y) (11)

Here, the vector U(x, y) is the motion vector that is subjected to the scale transformation. ρ is the ratio of the resolution of the input frame Isrc and the resolution of the storage buffer IB.

The position is determined where the value I_{src}(x, y) of the pixel of the input frame Isrc is stored. Using the motion vector subjected to the scale transformation, the storage position coordinate on the storage buffer IB is

$$\begin{matrix}[ Formula 12 ] & \\ D ( x , y ) = ρ [ \begin{matrix}x \\ y\end{matrix} ] + U ( x , y ) & ( 12 )\end{matrix}$$

Here, ρ is the ratio of the resolution of the input frame Isrc and the resolution of the storage buffer IB.

Thus, the warping unit 20 performs the movement (the warping) of the position of the pixel positioned at the coordinates (x, y) of the input frame Isrc based on the motion vector. In other words, the position of the subject (the object) is moved inside the input image based on the motion vector. Thus, the alignment of the input frame Isrc with respect to the reference frame Iref is performed.

The image after the warping of the input frame Isrc is stored in the storage buffer IB. Namely, the pixel value I_{src}(x, y) of the input frame Isrc is stored in the storage buffer IB. The storage position coordinate is the coordinate D(x, y) as determined by the warping unit 20. The storage position coordinate may be in decimals. Therefore, the discrete ordinate at the vicinity of the storage position coordinate is determined.

$$\begin{matrix}[ Formula 13 ] & \\ X = [ \begin{matrix}X \\ Y\end{matrix} ] = round ( D ( x , y ) ) & ( 13 )\end{matrix}$$

Here, the vicinity discrete ordinate is expressed by

[Formula 14].

x=(X,Y)^{T} (14)

Each component of the storage position coordinate being rounded to the nearest whole number is expressed by

[Formula 15].

round(D(x,y)) (15)

The storing is implemented as follows by adding the input pixel to the vicinity discrete ordinate.

B(X,Y)+=I_{src}(x,y)

Here, “z+=a” expresses that “a” being added to “z”.

The weight of storing is stored in the storing weight buffer IW for each of the pixels of the storage buffer IB. Namely, the calculation of

W(X,Y)+=1.0

is implemented.

Thus, the input frame Isrc is stored in the storage buffer IB. As shown in FIG. 2, after the first operation A1 or the second operation A2, the multiple input frames Isrc are stored in the storage buffer IB by further implementing the first operation A1. For example, the weight W(X, Y) of each pixel is the number of times the input frame Isrc is stored for the pixel.

The weight W(X, Y) may be changed according to the reliability of the estimation. For example, when the motion of the subject is abrupt and the motion vector is large, the weight may be changed according to the magnitude of the motion vector. That is, the value that is added to the storing weight buffer IW is changed according to the magnitude of the motion vector that is estimated. For example, the value that is added to the storing weight buffer is set to be less in the case where the motion vector is large than in the case where the magnitude of the motion vector is small. Thereby, the error of the storing can be suppressed.

For example, in an image processing device that stores input frames that are input moment to moment, the error of the alignment may become large when the shift (the motion vector) between the reference frame and the input frame is too large. For example, circumstances are assumed where the hand unsteadiness range of a camera becomes large over time. The image quality of the output frame that is generated degrades due to the increase of the error of the alignment. In such a case, the number of frames that can be stored is limited by the range in which the position can be corrected.

Conversely, in the image processing device 100 according to the embodiment, the reference frame Iref is replaced with the input frame Isrc as appropriate. Thereby, the error of the alignment can be suppressed; and a high-quality image can be generated. In the replacement determination, it is determined whether or not to implement such a replacement of the reference frame Iref.

In step S14, the replacement determination unit 40 determines the relationship between the reference frame Iref and the input frame Isrc and determines whether or not to implement the replacement. For example, it is determined to replace the reference frame Iref when a constant amount of time has elapsed from the time when the reference frame Iref was acquired or when the displacement of the input frame Isrc with respect to the reference frame Iref is not less than a constant amount. Step S14 may be implemented prior to step S13.

The reference for whether or not to replace the reference frame Iref with the input frame Isrc is whether or not there is some meaning to the separation of the input frame Isrc and the reference frame Iref. By replacing the reference frame Iref, the input frame Isrc and the reference frame Iref do not separate from each other by not less than a constant amount. Thereby, the error of the alignment can be suppressed.

The calculator 50 again implements the first operation A1 when the relationship between the reference frame Iref and the input frame Isrc does not satisfy the determination condition, that is, when it is determined not to implement the replacement. The calculator 50 implements the second operation A2 when the relationship between the reference frame Iref and the input frame Isrc satisfies the determination condition, that is, when it is determined to implement the replacement. After implementing the second operation A2, the calculator 50 further implements the first operation A1 using the reference frame Iref replaced with the second operation A2. Thus, the multiple input frames Isrc are stored in the storage buffer IB.

Step S15 and step S16 are implemented in the case where it is determined to implement the replacement. The order in which step S15 and step S16 of the second operation A2 are implemented may be interchanged; and step S15 and step S16 may be implemented simultaneously. In step S16, the reference frame Iref is replaced with the current input frame Isrc.

As described above, after replacing the reference frame Iref, the first operation A1 is implemented again; and the input frame Isrc is stored in the storage buffer IB. However, the storage buffer IB corresponds to the time when the reference frame Iref before the replacement was acquired. In other words, the position of the subject in the storage buffer IB is matched to the position of the same subject in the reference frame Iref before the replacement. Therefore, in the case where the reference frame Iref is replaced, the position of the subject in the reference frame Iref after the replacement is different from the position of the subject in the previous storage buffer IB (a first storage image IB1). The input frame Isrc that is aligned with the reference frame Iref after the replacement cannot be stored as-is in the storage buffer IB before the replacement of the reference frame Iref.

Therefore, in step S15, the motion compensator 30 moves (performs a motion compensation of) the position of the storage buffer IB (the first storage image IB1) toward the position of the current input frame Isrc using the motion vector. Thus, the previous storage buffer IB (first storage image IB1) is replaced with the storage buffer IB (a second storage image IB2) moved based on the motion vector.

In other words, in the second operation A2, the calculator 50 derives the second storage image IB2 in which the position of the subject inside the first storage image IB1 is moved based on the motion vector, and determines to set the second storage image IB2 to be the new first storage image IB1.

The motion compensation of the storage buffer IB is implemented as follows. First, the relationship between the coordinates (x, y) and the coordinates (X, Y) is as follows.

$$\begin{matrix}[ Formula 16 ] & \\ {( x , y )}^{T} = {( \frac{1}{ρ} X , \frac{1}{ρ} Y )}^{T} & ( 16 )\end{matrix}$$

The motion vector at the position of the coordinates (X, Y) is as follows.

$$\begin{matrix}[ Formula 17 ] & \\ U ( x , y ) = U ( \frac{1}{ρ} X , \frac{1}{ρ} Y ) = {( {U}_{x} ( \frac{1}{ρ} X , \frac{1}{ρ} Y ) , {U}_{y} ( \frac{1}{ρ} X , \frac{1}{ρ} Y ) )}^{T} & ( 17 )\end{matrix}$$

Here, Uₓ is the x-component of the motion vector; and U_{y} is the y-component of the motion vector. However, because the motion vector is defined only at discrete pixel positions, there is a possibility that

$$\begin{matrix}[ Formula 18 ] & \\ U ( \frac{1}{ρ} X , \frac{1}{ρ} Y ) & ( 18 )\end{matrix}$$

does not exist. Therefore, it is sufficient to interpolate the motion vector of Formula (22) using a linear interpolation, etc. It is sufficient for the restoration by the motion compensation to be as follows.

$$\begin{matrix}[ Formula 19 ] & \\ B ( X , Y ) = α B ( X + {U}_{x} ( \frac{1}{ρ} X , \frac{1}{ρ} Y ) , Y + {U}_{y} ( \frac{1}{ρ} X , \frac{1}{ρ} Y ) ) & ( 19 )\end{matrix}$$

The value B(X, Y) of the storage buffer IB is defined only at discrete pixel positions. Therefore, here as well, it is sufficient to perform the calculation by using an interpolation such as a linear interpolation, etc. The motion compensation is performed similarly for the storing weight buffer IW as well.

Here, α is a coefficient having the value of 0≦α≦1. The proportion of the previous storage buffer IB that is inherited by the next storage buffer IB can be adjusted using α. For example, α is reduced when the motion vector that is estimated is large such as when the motion of the subject is abrupt, etc. In other words, the value of the pixel of the second storage image is determined according to the magnitude of the motion vector. Thereby, the error of the storing can be suppressed.

Thus, the multiple input frames Isrc are stored in the storage buffer IB. By implementing step S17 and step S18 as shown in FIG. 2, the output frame IO is generated from the storage buffer IB and output.

The generation and output of the output frame IO is implemented as appropriate. For example, the output is performed once after the storing is performed multiple times. The output frame IO may be output each time the storing is performed.

The weight of storing is different between the pixels of the storage buffer IB. Therefore, the output frame IO (the output image) is derived based on the storage buffer IB and the weight of each of the pixels of the storage buffer IB. In step S17, the value of the storage buffer IB is divided by the weight of the storing weight buffer IW. Thereby, the output frame IO is generated. The output frame IO (the stored output frame) can be calculated as follows.

$$\begin{matrix}[ Formula 20 ] & \\ O ( X , Y ) = \frac{B ( X , Y )}{W ( X , Y )} & ( 20 )\end{matrix}$$

Thus, the output frame IO that is calculated is output in step S18; and a high-quality image is obtained.

The storage buffer IB considering the weight of storing may be derived each time the input frame Isrc is stored. However, as recited above, it is favorable for the output frame IO to be generated using the storage buffer IB and the storing weight buffer IW when performing the output because the noise reduction effect is high.

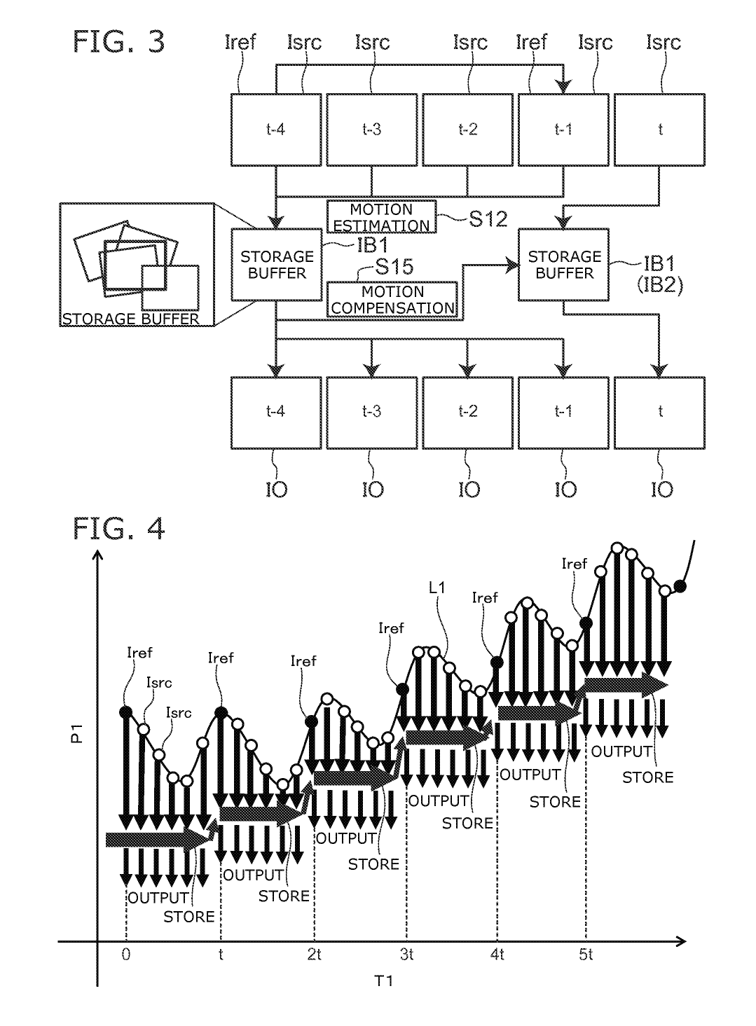

FIG. 3 is a schematic view illustrating the operations of the image processing device according to the first embodiment.

As shown in FIG. 3, for example, the input frame Isrc is acquired at each of time t-4 to time t. Each of the multiple input frames Isrc is stored in the storage buffer IB. In the example, the output frame IO is output from the storage buffer IB at each of time t-4 to time t.

In the example, first, the input frame Isrc of time t-4 is set to be the reference frame Iref (a first reference image). Subsequently, the motion estimation with respect to the reference frame Iref is performed sequentially for the input frames Isrc that are acquired at time t-3, time t-2, and time t-1. Each of the input frames Isrc is stored in the storage buffer IB (the first storage image IB1) based on the estimated motion vector.

For example, the calculator 50 moves the position of the subject inside the input frame Isrc based on the motion vector. Thereby, the position of the subject inside the input frame Isrc matches the position of the subject inside the reference frame Iref. At least a portion of the image after moving the input frame Isrc (a first target image) is stored in the storage buffer IB.

Here, it is supposed that the relationship between the reference frame Iref (i.e., the input frame Isrc of time t-4) and the input frame Isrc of time t-1 satisfies the determination condition. In such a case, the reference frame Iref is replaced with the input frame Isrc of time t-1. In other words, the input frame Isrc of time t-1 is set to be the new reference frame Iref (a second reference image).

Further, in the second operation A2, the calculator 50 derives the second storage image IB2 based on the motion vector (first motion vector) of the input frame Isrc of time t-1 with respect to the reference frame Iref before the replacement. The second storage image IB2 is, for example, the image in which the position of the subject inside the first storage image IB1 is moved based on the motion vector. The position of the subject in the second storage image IB2 is matched to the position of the subject in the input frame Isrc. Then, the second storage image IB2 is set to be the new first storage image IB1. Thus, a new storage buffer IB is derived that inherits the storage results of the input frames Isrc of and before time t-1.

The motion estimation with respect to the replaced reference frame Iref is performed for the input frame Isrc of time t (second target image). The input frame Isrc of time t is stored in the replaced storage buffer IB (second storage image IB2) based on the estimated motion vector (second motion vector).

As explained above, the calculator 50 adds at least a portion of the first target image (the input frame Isrc of time t-1) to the first storage image based on the first motion vector between the first reference image (the input frame Isrc of time t-4) and the first target image. The calculator 50 sets the first target image to be the second reference image when a relationship between the first reference image and the first target image satisfies the determination condition. Further, the calculator 50 adds at least a portion of the second target image (the input frame Isrc of time t) to the second storage image based on the second motion vector between the second reference image and the second target image, the second storage image is based on a sum of the at least the portion of the first target image and the first storage image.

Thus, for example, the storage buffer IB and the reference frame Iref are replaced to match the change of the imaging scene of the input frame Isrc. Thereby, a high-quality image can be obtained.

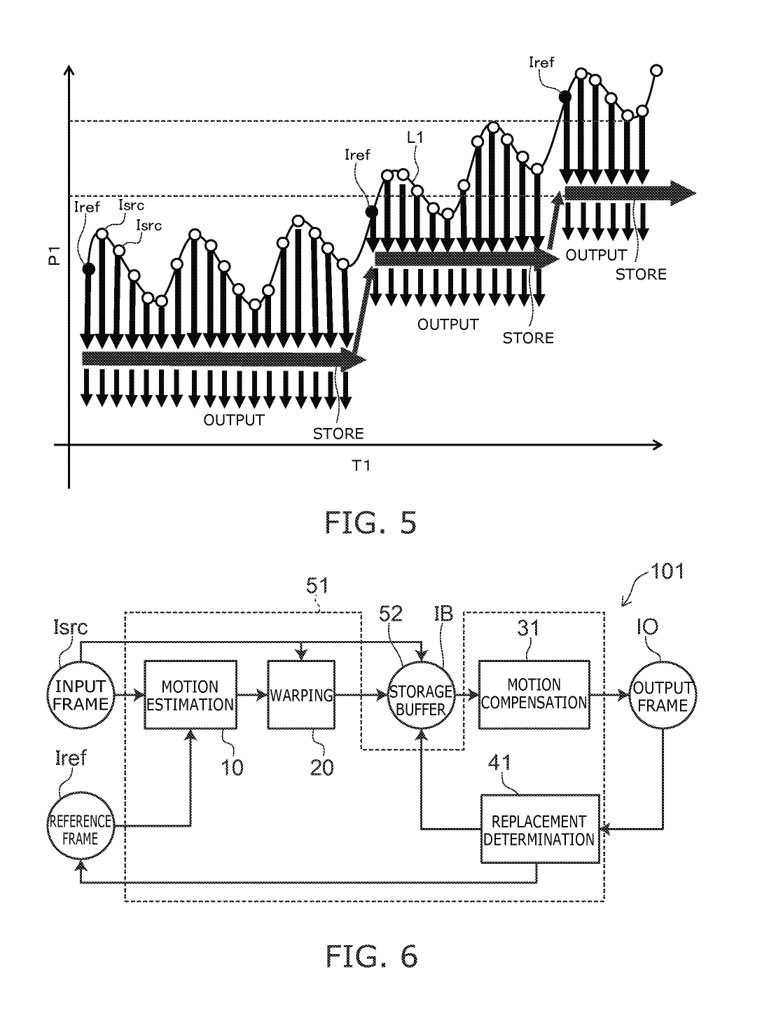

FIG. 4 and FIG. 5 are schematic views illustrating operations of the image processing device according to the first embodiment.

In FIG. 4 and FIG. 5, the horizontal axis is time T1; and the vertical axis is a position P1 of the image. For example, a curve L1 illustrates the position of the input frame Isrc at each time. For example, the curve L1 corresponds to the path of the hand unsteadiness of a camera imaging the input frame Isrc. The circles on the curve L1 illustrate the time when the input frame Isrc is acquired.

In the example shown in FIG. 4, the determination condition of replacing the reference frame Iref is determined based on the length between the time when the reference frame Iref is acquired and the time when the input frame Isrc is acquired.

For example, the time when the reference frame Iref is acquired is the time when any one of the multiple input frames Isrc is acquired. When the difference between the time when the reference frame Iref is acquired and the time when the current input frame Isrc is acquired is larger than a preset reference value, it is determined to replace the reference frame Iref.

As shown in FIG. 4, the reference frame Iref is replaced each elapse of time t. When the replacement is performed, the storage buffer IB is updated by the motion compensation. Thus, the storing is performed while replacing the reference frame; and the storing can be continued by inheriting the storage results when replacing. Thereby, for example, a high-quality image can be obtained without limiting the number of frames that can be stored.

The determination condition may be determined based on the number of multiple input frames Isrc acquired after the reference frame Iref is acquired. In other words, the determination condition may be determined based on the number of times the first operation A1 is implemented. For example, it is determined to replace the reference frame Iref when the number of input frame Isrc frames acquired after the reference frame Iref is acquired exceeds the reference value. In the example of FIG. 4, the reference frame Iref is replaced every sixth frame. For example, the example of FIG. 4 is used for a video image of multiple input frames Isrc imaging a moving subject.

The determination condition may be determined according to the magnitude of the motion vector. For example, it is determined to replace the reference frame Iref when the motion vector exceeds a constant magnitude. For example, the maximum value of the magnitude of the motion vector in the screen may be used as the magnitude of the motion vector; or, the average value of the motion vector in the screen may be used.

For example, the change of the position P1 of the vertical axis of FIG. 5 corresponds to the change of the magnitude of the motion vector. In the example, the reference frame Iref is replaced when the difference between the position P1 of the reference frame Iref and the position P1 of the input frame Isrc exceeds a constant magnitude. Thereby, the storing can be continued even when the shift (the motion vector) between the reference frame and the input frame is large.

The determination condition may be determined based on the ratio (the coverage ratio) of the surface area of the reference frame Iref and the surface area of the overlap between the reference frame Iref and the image after the movement of the input frame Isrc (after the warping). The coverage ratio is the proportion of the surface area of the input frame Isrc that covers the reference frame Iref after the movement of the input frame Isrc based on the motion vector. The masking of the reference of the motion vector is as follows.

[Formula 21]

m(x+uₓ(x,y),y+u_{y}(x,y))=1.0 (21)

The mask is initialized to 0. At this time, the coverage ratio is defined as follows.

$$\begin{matrix}[ Formula 22 ] & \\ \frac{{\sum }_{x , y} m ( x , y )}{N} & ( 22 )\end{matrix}$$

N is the total number of pixels. For example, the coverage ratio is 1 when the position of the subject in the input frame Isrc has not moved at all from the position of the subject in the reference frame Iref. For example, it is determined to implement the replacement if the coverage ratio is not more than a constant value.

The determination condition may be determined based on the difference between the value of the pixel included in the reference frame Iref and the value of the pixel included in the input frame Isrc. For example, a difference value such as the following may be used as a reference.

$$\begin{matrix}[ Formula 23 ] & \\ \frac{1}{N} {\sum }_{x , y} {( {I}_{src} ( x , y ) - {I}_{ref} ( x + {u}_{x} ( x , y ) , y + {u}_{y} ( x , y ) ) )}^{2} & ( 23 )\end{matrix}$$

The difference value is 0 when the input frame Isrc and the reference frame Iref are the same. The value of the difference value increases as the change of the input frame Isrc with respect to the reference frame Iref increases. It is determined to perform the replacement if the difference value is not less than a constant amount.

The determination conditions described above may be used independently or in combination. Thereby, the accumulation of alignment errors is suppressed; and a high-quality image can be obtained.

### Second Embodiment

FIG. 6 is a block diagram illustrating an image processing device according to a second embodiment.

FIG. 6 shows a calculator 51 of the image processing device 101 according to the second embodiment.

As shown in FIG. 6, the calculator 51 includes the motion estimator 10 and the warping unit 20. The description of these components is similar to that of the first embodiment. The calculator 51 further includes a motion compensator 31 and a replacement determination unit 41.

As described above, the storage buffer IB corresponds to the time when the reference frame Iref is acquired. In other words, the position of the subject in the storage buffer IB is matched to the position of the same subject in the reference frame Iref.

The motion compensator 31 causes the storage buffer IB to match the time when the input frame Isrc is acquired. In other words, the position of the subject in the storage buffer IB is caused to match the position of the same subject in the input frame Isrc (is restored by the motion compensation). For example, the processing of the motion compensator 31 is implemented and the output frame IO is derived each time the input frame Isrc is acquired (each time the first operation A1 is performed). Thereby, the multiple input frames Isrc that are input can be output as a high-quality video image.

The replacement determination unit 41 determines the relationship between the reference frame Iref and the input frame Isrc and determines whether or not to implement the replacement of the reference frame Iref. In the example, the output frame IO corresponds to the time when the input frame Isrc is acquired.

The processing of the motion compensator 31 is implemented as follows.

The relationship between the coordinates (x, y) and the coordinates (X, Y) is as follows.

$$\begin{matrix}[ Formula 24 ] & \\ {( x , y )}^{T} = {( \frac{1}{ρ} X , \frac{1}{ρ} Y )}^{T} & ( 24 )\end{matrix}$$

The motion vector at the position of the coordinates (X, Y) is as follows.

$$\begin{matrix}[ Formula 25 ] & \\ U ( x , y ) = U ( \frac{1}{ρ} X , \frac{1}{ρ} Y ) = {( {U}_{x} ( \frac{1}{ρ} X , \frac{1}{ρ} Y ) , {U}_{y} ( \frac{1}{ρ} X , \frac{1}{ρ} Y ) )}^{T} & ( 25 )\end{matrix}$$

Here, Uₓ is the x-component of the motion vector. U_{y} is the y-component of the motion vector. However, because the motion vector is defined only at discrete positions, there is a possibility that

$$\begin{matrix}[ Formula 26 ] & \\ U ( \frac{1}{ρ} X , \frac{1}{ρ} Y ) & ( 26 )\end{matrix}$$

does not exist. Therefore, it is sufficient to interpolate the motion vector of Formula (22) using a linear interpolation, etc. It is sufficient for the restoration by the motion compensation to be as follows.

$$\begin{matrix}[ Formula 27 ] & \\ O ( X , Y ) = O ( X + {U}_{x} ( \frac{1}{ρ} X , \frac{1}{ρ} Y ) , Y + {U}_{y} ( \frac{1}{ρ} X , \frac{1}{ρ} Y ) ) & ( 27 )\end{matrix}$$

The value of O(X, Y) is defined only at discrete positions. Therefore, here as well, it is sufficient to perform the calculation by using an interpolation such as a linear interpolation, etc. Thus, in the second embodiment, the position of the subject inside the storage buffer IB is moved based on the motion vector. Thereby, the output frame IO (the output image) is generated in which the position of the subject inside the storage buffer IB matches the position of the subject inside the input frame Isrc.

In the first embodiment, the motion compensation of the storage buffer IB is implemented in the case where it is determined to replace the storage buffer. Conversely, in the example, the motion compensation of the storage buffer IB is performed every input frame. Therefore, the motion compensation may not be performed anew when it is determined to implement the replacement. In such a case, it is sufficient for the storage buffer IB to be replaced with the output frame IO subjected to the motion compensation.

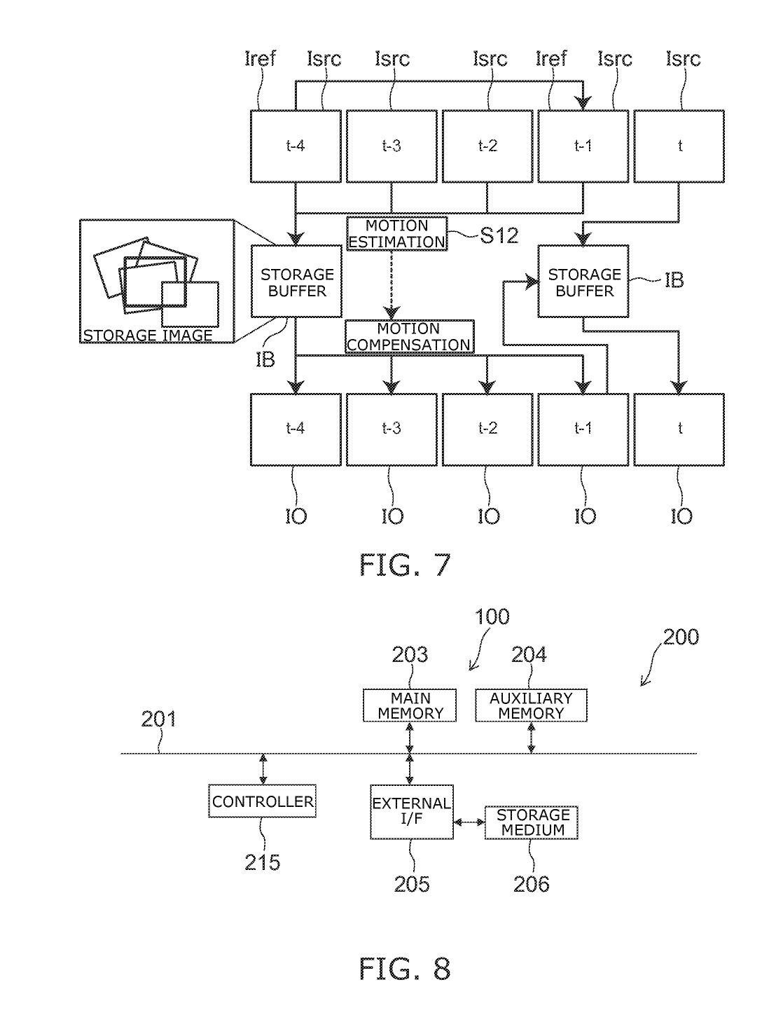

FIG. 7 is a schematic view illustrating operations of the image processing device according to the second embodiment.

As shown in FIG. 7, the input frame Isrc is acquired and the output frame IO is output for each of time t-4 to time t.

At each time, the motion compensation of the storage buffer IB is performed according to the motion vector determined by the motion estimation; and the output frame IO is derived.

Similarly to the example of FIG. 3, in this example as well, the replacement of the reference frame Iref is implemented for time t-1. At this time, the storage buffer IB is replaced with the output frame IO of time t-1. The error of the storing is suppressed; and a high-quality video image can be obtained.

### Third Embodiment

FIG. 8 is a schematic view illustrating an image processing device according to a third embodiment.

A computer device 200 shown in FIG. 8 is, for example, capable of implementing the image processing described in regard to the first to third embodiments. The computer device 200 is, for example, an image processing device.

The computer device 200 shown in FIG. 8 includes a bus 201, a controller 202, a main memory 203, an auxiliary memory 204, and an external I/F 205. The controller 202, the main memory 203, the auxiliary memory 204, and the external I/F 205 are connected to the bus 201.

The auxiliary memory 204 includes, for example, a hard disk, etc. For example, a storage medium 206 is connected to the external I/F 205. The storage medium 206 includes, for example, CD-R, CD-RW, DVD-RAM, DVD-R, etc.

For example, a program for executing the processing of the image processing device 100 is stored in the main memory 203 or the auxiliary memory 204. The processing of the image processing device 100 is executed by the controller 202 executing the program. In the execution of the processing of the image processing device 100, for example, the main memory 203 or the auxiliary memory 204 is used as a buffer that stores each frame.

For example, the program for executing the processing of the image processing device 100 is preinstalled in the main memory 203 or the auxiliary memory 204. The program may be stored in the storage medium 206. In such a case, for example, the program is installed as appropriate in the computer device 200. The program may be acquired via a network.

### Fourth Embodiment

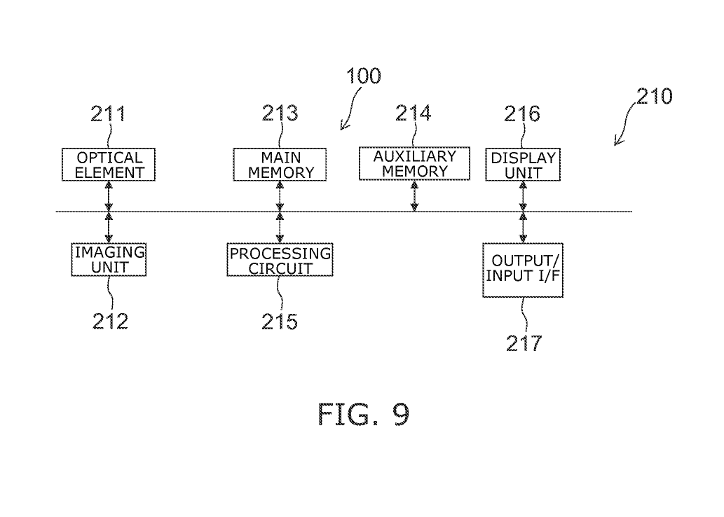

FIG. 9 is a schematic view illustrating an imaging device according to a fourth embodiment.

As shown in FIG. 9, the imaging device 210 includes an optical element 211, an imaging unit (an imaging element) 212, a main memory 213, an auxiliary memory 214, a processing circuit 215, a display unit 216, and an output/input I/F 217.

For example, a lens or the like is provided in the optical element 211. A portion of the light from the subject toward the imaging device 210 passes through the optical element 211 and is incident on the imaging unit 212. The imaging unit 212 includes, for example, a CMOS image sensor, a CCD image sensor, etc. The reference frame Iref and the input frame Isrc are imaged by the optical element 211 and the imaging unit 212. For example, the program for executing the processing of the image processing device 100 is pre-stored in the main memory 213 or the auxiliary memory 214. The program is executed by the processing circuit 215; and the processing of the image processing device 100 is executed. In other words, in the example, the processing of the image processing device 100 is implemented by the main memory 213, the auxiliary memory 214, and the processing circuit 215. In the execution of the processing of the image processing device 100, for example, the main memory 213 or the auxiliary memory 214 is used as a buffer that stores each frame. The output frame is output by the processing of the image processing device 100. For example, the output frame is displayed by the display unit 216 via the output/input I/F 217.

In other words, the imaging device 210 includes, for example, the imaging unit 212 and any image processing device according to the embodiments recited above. The imaging unit 212 acquires, for example, the image information (e.g., the reference frame and the input frame) that is acquired by the image processing device.

According to the embodiment, an image processing device, an imaging device, and an image processing method that generate a high-quality image can be provided.

Hereinabove, embodiments of the invention are described with reference to specific examples. However, the embodiments of the invention are not limited to these specific examples. For example, one skilled in the art may similarly practice the invention by appropriately selecting specific configurations of components such as the calculator, the motion estimator, the warping unit, the motion compensator, the replacement determination unit, the main memory, the auxiliary memory, the controller, the processing circuit, the display unit, the imaging unit, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all image processing devices, imaging devices, and image processing methods practicable by an appropriate design modification by one skilled in the art based on the image processing devices, the imaging devices, and the image processing methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processing device, comprising:
memory that stores a first storage image; and
a calculator that adds at least a portion of a target image to the first storage image based on a motion vector between a reference image and the target image, and determines to replace the reference image with the target image when a relationship between the reference image and the target image satisfies a determination condition.

2. The image processing device according to claim 1, wherein the calculator further calculates, when the determination condition is satisfied, a motion vector using the replaced reference image.

3. The image processing device according to claim 1, wherein the calculator calculates the motion vector according to a difference between a position of an object inside the reference image and a position of the object inside the target image, moves a position of the object inside the first storage image to derive a second storage image based on the motion vector, and replaces the first storage image with the second storage image.

4. The image processing device according to claim 3, wherein the calculator determines a value of a pixel of the second storage image according to a magnitude of the motion vector.

5. The image processing device according to claim 1, wherein the determination condition is a condition determined based on a length of time between a time of acquiring the reference image and a time of acquiring the target image.

6. The image processing device according to claim 1, wherein
the calculator acquires a plurality of an input images including the target image, and
the determination condition is a condition determined based on a number of the input images acquired after the reference image.

7. The image processing device according to claim 1, wherein the calculator moves a position of the target image based on the motion vector, and adds at least a portion of an image after the movement of the target image to the first storage image.

8. The image processing device according to claim 7, wherein the determination condition is a condition determined based on a ratio of a surface area of the reference image and a surface area of an overlap between the reference image and the image after the movement of the target image.

9. The image processing device according to claim 1, wherein the determination condition is a condition determined based on a difference between a value of a pixel included in the reference image and a value of a pixel included in the target image.

10. The image processing device according to claim 1, wherein the calculator derives an output image based on the first storage image and a weight of storing for each pixel of the first storage image.

11. The image processing device according to claim 10, wherein the weight is determined according to a magnitude of the motion vector.

12. The image processing device according to claim 1, wherein the calculator generates an output image based on the motion vector, a position of an object inside the first storage image being moved in the output image.

13. An imaging device, comprising:
the image processing device according to claim 1; and
an imaging element that images the target image.

14. An image processing method, comprising:
acquiring an target image and adding at least a portion of the target image to a first storage image based on a motion vector between a reference image and the target image; and
replacing the reference image with the target image when a relationship between the reference image and the target image satisfies a determination condition.

15. The method according to claim 14, further comprising calculating, when the determination condition is satisfied, a motion vector using the replaced reference image.

16. The method according to claim 14, wherein the motion vector is calculated according to a difference between a position of an object inside the reference image and a position of the object inside the target image.

17. The method according to claim 14, further comprising moving a position of the object inside the first storage image to derive a second storage image based on the motion vector, and replacing the first storage image with the second storage image.

18. The method according to claim 14, wherein the determination condition is a condition determined based on a length of time between a time of acquiring the reference image and a time of acquiring the target image.

19. An image processing device, comprising:
memory that stores a first storage image; and
a calculator that adds at least a portion of a first target image to the first storage image based on a first motion vector between a first reference image and the first target image, and makes the first target image to be a second reference image when a relationship between the first reference image and the first target image satisfies a determination condition.

20. The image processing device according to claim 19, wherein the calculator adds at least a portion of a second target image to a second storage image based on a second motion vector between the second reference image and the second target image, the second storage image is based on a sum of the at least the portion of the first target image and the first storage image.
